(19) United States
(12) Patent Application Publication
(10) Pub. No.: US 2023/0223596 A1
(43) Pub. Date: Jul. 13, 2023

(54) CAPACITY-COMPENSATION ELECTROLYTE, SECONDARY BATTERY CONTAINING THE SAME AND APPLICATION

(71) Applicant: TIANJIN UNIVERSITY, Tianjin (CN)

(72) Inventors: Jie SUN, Tianjin (CN); Xiaoyi WANG, Tianjin (CN)

(21) Appl. No.: 17/980,220

(22) Filed: Nov. 3, 2022

(30) Foreign Application Priority Data
Jan. 10, 2022 (CN) 2022100233294

(51) Int. Cl. H01M 10/0567; H01M 10/0525; H01M 10/054; H01M 10/0568; H01M 10/0569

(52) U.S. Cl. CPC H01M 10/0567; H01M 10/0525; H01M 10/054; H01M 10/0568; H01M 10/0569; H01M 2300/0028

(57) ABSTRACT

The present disclosure discloses a capacity-compensation electrolyte, comprising: an organic solvent, an electrolyte salt and an electrolyte additive capable of compensating ions and electrons simultaneously; wherein the electrolyte additive comprises: a component capable of compensating ions and electrons simultaneously, or a composition of a component capable of compensating ions and a component capable of compensating electrons; the component capable of compensating ions and electrons simultaneously refers to a component capable of decomposing and releasing active ions and electrons simultaneously in the electrolyte during the working process of the battery; the component capable of compensation ions refers to a component capable of decomposing and releasing active ions in the electrolyte during the working process of the battery solution; and the component capable of compensation electrons refers to a component capable of decomposing and releasing electrons in the electrolyte during the working process of the battery solution.

### CROSS-REFERENCE TO RELATED APPLICATIONS

This application claims priority from the Chinese patent application 2022100233294 filed Jan. 10, 2022, the content of which is incorporated herein in the entirety by reference.

### TECHNICAL FIELD

The present disclosure relates to the field of secondary batteries, in particular to a capacity-compensation electrolyte capable of compensating ions and electrons simultaneously and application thereof.

### BACKGROUND

With the wide application of portable electronic products and electric vehicles, the development of secondary batteries with higher capacity has become a research hotspot. However, during first charge and discharge cycle of the secondary batteries, a Solid Electrolyte Interphase (SEI) is formed on the surface of an anode due to the decomposition of an electrolyte solution, which may consume a certain quantity of active ions, leading to low initial Coulomb efficiency and energy density of the battery. There is also a Cathode Electrolyte Interphase (CEI) formed on a cathode side due to electrolyte decomposition, and the energy density of the overall battery may be reduced due to mismatching of the initial Coulomb efficiency of the cathode and the anode. Dead lithium/sodium/potassium may be generated due to large volume expansion rates of anodes featuring alloying reaction mechanisms with high theoretical specific capacities such as a phosphorus-based anode and a silicon-based anode in the cycle process; and the electronic conductivity of products in the process is low as for metal oxide anodes and the like featuring the conversion reaction mechanism, and dead lithium/sodium/potassium is also easily generated in the deionization process, resulting in losses of active ions.

In order to achieve higher energy density, a lithium compensation technology has been widely researched in lithium-ion batteries. Additional lithium sources are added to the batteries to compensate for lithium losses generated in the forming process of SEI. Prelithiation at the anode mainly refers to lithium compensation by means of lithium foil and lithium powder. For example, the patent CN109728306 discloses a lithium compensation anode plate, including an anode current collector, first anode slurry layers on both surfaces of the anode current collector, lithium foil layers attached to surfaces of the first anode slurry layers and second anode slurry layers on surfaces of the lithium foil layers. Compared with the lithium foil, the lithium powder can more precisely control the amount of supplemented lithium, for example, CN113097448A adopts a lithium compensation mode by means of the lithium powder, but may face problems such as dust control, high requirements for production environments, low safety and the like in the production process, and a binder needs to be additionally added, leading to reduction in energy density to a certain degree. Lithium compensation at the cathode is also one of the common manners. For example, in the patent CN107248567B, compounds of lithium oxides and transition metal oxides are adopted as lithium compensation additives. However, the cathode lithium compensation additives usually produce gas during decomposition, resulting in irreversible damage to electrode structures.

An electrolyte is one of the important components of the batteries, as for prelithiation of the electrolyte solution, a general method is to add lithium salts capable of decomposing to release lithium ions into electrolyte solvents, but there are problems that the solubility of some lithium salts is low in the electrolyte solvent, and that an additive needs to be additionally added, for example, in the patent CN112448037, lithium nitride and/or lithium oxalate are/is adopted as a lithium compensation compound, but tri(pentafluorophenyl) borane, tri(pentafluorophenyl) phosphine or tri(pentafluorophenyl) silane is also needed as a co-solvent. In the patent CN 113258139 A, besides lithium acetate, lithium trifluoroacetate and n-butyllithium for supplying lithium sources, the electrolyte needs to be used in combination with a first solvent for prelithiation and a second solvent for preventing co-intercalation, so that the formula of the electrolyte is complex.

### SUMMARY

A first technical problem to be solved by the present application is to provide a capacity-compensation type electrolyte solution. Losses of active ions in the first cycle and the follow-up cycle processes can be uniformly and effectively compensated by adding a certain quantity of a liquid capacity-compensation additive to the electrolyte solution. By adding additive to the electrolyte solution, the present disclosure avoids influences on electrode structures and additional requirements on a binder, and has higher compatibility with existing process conditions.

By adding a component capable of compensating ions and electrons simultaneously or a composition of a component capable of compensating ions and a component capable of compensating electrons to the electrolyte solution, ions and electrons can be compensated simultaneously, the losses of the active ions can be compensated during charge and discharge of a battery, and the component with low oxidation potential can preferentially decompose to supply electrons.

The other technical problem to be solved by the present application is to provide a secondary ion battery. The secondary ion battery contains the capacity-compensation type electrolyte solution, which has high cycle stability.

The term “capacity-compensation” used in the present disclosure refers to compensation for capacity losses caused by various reasons such as the side reaction at the electrode-electrolyte interfaces during the first cycle of the secondary battery, SEI and CEI formed during the side reaction and the pulverization of electrode materials in the follow-up cycle processes, including active ions and electrons generated by decomposition of the additive.

The term “electron compensation” used in the present disclosure refers to the situation that a part of electrons may be provided to compensate for the capacity losses of the electrode materials in the decomposition process of the additive when the oxidation potential of the additive is lower than that of the cathode material.

The term “ion compensation” used in the present disclosure refers to the situation that a part of active ions may be supplied to compensate for the capacity losses of the electrode materials in the decomposition process of the additive.

In order to solve the first problem of the present application, the present application adopts the following technical solutions:

A capacity-compensation electrolyte capable of compensating ions and electrons includes a non-aqueous organic solvent, an electrolyte salt and an electrolyte additive capable of compensating ions and electrons simultaneously. Wherein the additive is a component capable of compensating ions and electrons simultaneously, or a composition of a component capable of compensating ions and a component capable of compensating electrons.

In the present disclosure, the “component capable of compensating ions and electrons simultaneously” refers to a component capable of decomposing and releasing active ions and electrons at the same time in the working process of the electrolyte, which can independently act to achieve capacity compensation.

In the present disclosure, a “composition of the component capable of compensating ions and the component capable of compensating electrons” refers to the situation that the component capable of decomposing to provide the active ions in the electrolyte during the working process of the battery and the component capable of supplying the electrons with an oxidation potential lower than that of the cathode material are added to the electrolyte together, so as to achieve capacity compensation.

In the present disclosure, “active ions” refer to ions capable of being reversibly deintercalated between a cathode and an anode of the secondary battery.

As a further improvement of the technical solutions, the component capable of compensating ions and electrons simultaneously is selected from salts which contain active ion elements and have oxidation potential lower than that of the cathode material;

the component capable of compensating ions is selected from salts containing active ion elements; and

the component capable of compensating electrons is selected from one or more of ethers, sulfones, esters and thiophenes with oxidation potential lower than that of the cathode material.

As a further improvement of the technical solutions, in a lithium-ion battery, the component capable of compensating lithium and electrons simultaneously contains one or more combinations of LiₓP_{y} and LiₘSₙ, where, 0<x≤3, 0<y≤11, 2≤m≤4, and 2≤n≤8. The combination may be one or more combinations of LiₓP_{y}, one or more combinations of LiₘSₙ, one or more combinations of LiₓP_{y} and LiₘSₙ.

As a further improvement of the technical solutions, in LiₓP_{y} and LiₘSₙ, 1<x<3, 4≤y≤10, 2≤m≤4, and 2≤n≤6.

As a further improvement of the technical solutions, LiₓP_{y} is selected from one or more of LiP₄, LiP₅, LiP₇, LiP₈ and LiP₁₀.

As a further improvement of the technical solutions, LiₓP_{y} is selected from one or more of LiP₅ and LiP₇.

As a further improvement of the technical solutions, LiₓS_{y} is selected from one or more of Li₂S₄, Li₂S₆ and Li₂S₈.

As a further improvement of the technical solutions, LiₓS_{y} is selected from one or more of Li₂S₄ and Li₂S₆.

As a further improvement of the technical solutions, in the lithium-ion battery, the component capable of compensating electrons may be selected from one or more of NaₚP_{q} and KₑP_{f}, where, 0<p≤3, 0<q≤11, 0<e≤3, and 0<f≤11.

As a further improvement of the technical solutions, in NaₚP_{q} and KₑP_{f}, 1≤p<3, 4≤q≤10, 1≤e≤3, and 4≤f≤10.

As a further improvement of the technical solutions, NaₚP_{q} is selected from NaP₄, NaP₅, NaP₇ and NaP₁₀.

As a further improvement of the technical solutions, NaₚP_{q} is selected from NaP₅ and NaP₇.

As a further improvement of the technical solutions, KₑP_{f} is selected from KP₄, KP₅, KP₇ and K₃P₇.

As a further improvement of the technical solutions, KₑP_{f} is selected from KP₅ and K₃P₇.

As a further improvement of the technical solutions, in a sodium-ion battery, the component capable of compensating sodium and electrons simultaneously includes one or more combinations of NaₚP_{q}, where, 0<p≤3, and 0<q≤11.

As a further improvement of the technical solutions, in NaₚP_{q}, 1≤p<3, and 4≤q≤10.

As a further improvement of the technical solutions, NaₚP_{q} is selected from NaP₄, NaP₅, NaP₇ and NaP₁₀.

As a further improvement of the technical solutions, NaₚP_{q} is selected from NaP₅ and NaP₇.

As a further improvement of the technical solutions, in a potassium-ion battery, the component capable of compensating potassium and electrons simultaneously includes one or more combinations of KₑP_{f}, where, 0<e≤3, and 0<f≤11.

As a further improvement of the technical solutions, in KₑP_{f}, 1≤e≤3, and 4≤f≤10.

As a further improvement of the technical solutions, KₑP_{f} is selected from KP₄, KP₅, KP₇ and K₃P₇.

As a further improvement of the technical solutions, KₑP_{f} is selected from KP₅ and K₃P₇.

As a further improvement of the technical solutions, in the potassium-ion battery, the component capable of compensating electrons may be selected from one or more of NaₚP_{q}, where, 0<p≤3, and 0<q≤11.

As a further improvement of the technical solutions, in NaₚP_{q}, 1≤p<3, and 4≤q≤10.

As a further improvement of the technical solutions, NaₚP_{q} is selected from NaP₄, NaP₅, NaP₇ and NaP₁₀.

As a further improvement of the technical solutions, NaₚP_{q} is selected from NaP₅ and NaP₇.

As a further improvement of the technical solutions, the component capable of compensating electrons includes diethyl sulfone (DES), dimethyl sulfone (DMS), tris(trimethylsilyl) phosphite (TMSP), tri(pentafluorophenyl) phosphine (TPFPP), terthiophene (3THP), vinylene carbonate (VC) or phosphite P(X)(Y)(Z), where, X, Y and Z are equal to one or more combinations of OH, R, OR, Cl, SH, SR and R₂N (R═CₙH₂ₙ₊₁, phenyl and derivatives thereof and silyl and derivatives thereof);

as a further improvement of the technical solutions, the phosphite P(X)(Y)(Z) is selected from the group consisting of trimethyl phosphite (TMPi), tris(2,2,2-trifluoroethyl) phosphite, triphenyl phosphite (TPPi), tris(1,1,1,3,3,3-hexafluoro-2-propyl) phosphite, methyl phosphonic dichloride and trithiophosphite; and

as a further improvement of the technical solutions, the component capable of compensating electrons further includes ether molecules with low oxidization potential, and specifically includes one or more combinations of dimethoxyethane (DME), diethylene glycol dimethyl ether (DEGDME), triethylene glycol dimethyl ether (TEGDME), 1,1,2,2-tetrafluoroethyl-2,2,3,3-tetrafluoropropyl ether (TTE), 1,1,2,2-tetrafluoroethyl-2′,2′,2′-trifluoroethyl ether (HFE), ethyl nonafluorobutyl ether (EFE), diethylene glycol diethyl ether (G2E), 1,1,1,3,3,3-hexafluoroisopropyl methyl ether (HFPM), 1H,1H,5H-ocafluorentyl-1,1,2,2-tetrafluoroethyl ether (OFE), 2,2,2-trifluoroethyl ether (BTFE) and methyl nonafluorobutyl ether (MFE).

As a further improvement of the technical solutions, the ether molecules capable of compensating electrons are selected from DEGDME, EFE, HFPM and MFE.

As a further improvement of the technical solutions, in the lithium-ion battery, the component capable of compensating lithium is selected from one or more combinations of lithium hexafluorophosphate (LiPF₆), lithium tetrafluoroborate (LiBF₄), lithium perchlorate (LiClO₄), lithium hexafluoroarsenate (LiAsF₆), lithium bis(oxalate) borate (LiBOB), lithium difluoro(oxalato) borate (LiDFOB), lithium bis(fluorosulfonyl) imide (LiFSI), lithium bis(trifluoromethanesulfonyl) imide (LiTFSI), lithium trifluoromethanesulfonate (LiCF₃SO₃), lithium bis(trifluoromethylsulfonyl) imide (LiN(CF₃SO₂)₂) and lithium tetrafluorooxalate phosphate (LiPF₄(C₂O₄));

As a further improvement of the technical solutions, in the lithium-ion battery, the component capable of compensating lithium ions is selected from one or more combinations of LiPF₆, LiBOB, LiDFOB, LiFSI and LiTFSI.

As a further improvement of the technical solutions, in the lithium-ion battery, the component capable of compensating lithium is selected from LiFSI.

As a further improvement of the technical solutions, in the sodium-ion battery, the component capable of compensating sodium ions is selected from one or more combinations of sodium perchlorate (NaClO₄) and sodium hexafluorophosphate (NaPF₆).

As a further improvement of the technical solutions, in the sodium-ion battery, the component capable of compensating sodium is NaPF₆.

As a further improvement of the technical solutions, in the potassium-ion battery, the component capable of compensating potassium ions is selected from one or more combinations of potassium hexafluorophosphate (KPF₆), potassium bis(trifluoromethanesulfonly) imide (KTFSI) and potassium bis(fluorosulfonyl) imide (KFSI).

As a further improvement of the technical solutions, in the potassium-ion battery, the component capable of compensating potassium is KFSI.

As a further improvement of the technical solutions, in the lithium-ion battery, the composition of the components capable of compensating lithium and electrons is selected from LiPF₆/TMSP, LiDFOB/MFE, LiFSI/VC and LiTFSI/TMSP.

As a further improvement of the technical solutions, in the sodium-ion battery, the composition of the components capable of compensating sodium and electrons is selected from NaClO₄/EFE, NaPF₆/TMSP and NaPF₆/HFPM.

As a further improvement of the technical solutions, in the potassium-ion battery, the composition of the components capable of compensating potassium and electrons is selected from KPF₆/TMSP, KTFSI/TMPi and KFSI/TPPi.

As a further improvement of the technical solutions, the organic solvent includes one or more of an ester solvent, an ether solvent, a sulfone solvent and a nitrile solvent;

as a further improvement of the technical solutions, the ester solvent is selected from one or more of ethylene carbonate (EC), diethyl carbonate (DEC), dimethyl carbonate (DMC), ethyl methyl carbonate (EMC), propylene carbonate (PC), chlorocarbonate (Cl MC), ethyl propionate (EP) and propyl propionate (PP);

as a further improvement of the technical solutions, the ether solvent is selected from one or more of dimethoxyethane (DME), 1,3-dioxolane (DOL) and diglyme (DG);

as a further improvement of the technical solutions, the sulfone solvent is selected from one or more of sulfolane (SL) and dimethyl sulfoxide (DMSO); and

as a further improvement of the technical solutions, the nitrile solvent is selected from one or more of acetonitrile (AN), succinonitrile (SN) and hexanedinitrile (HN).

As a further improvement of the technical solutions, in the ester solvent, the solvent is selected from a combination of EC/DEC, EC/EMC, EC/EMC/DMC and PC/DMC;

as a further improvement of the technical solutions, in the ester solvent, the adaptive additive capable of compensating ions and electrons simultaneously is selected from one or more of LiP₅, LiP₇, NaP₅, NaP₇, KP₅ and K₃P₇;

as a further improvement of the technical solutions, in the ester solvent, the adaptive composition of the components capable of compensating lithium and electrons is selected from LiPF₆/TMSP and LiDFOB/MFE;

as a further improvement of the technical solutions, in the ester solvent, the composition of the adaptive components capable of compensating sodium and electrons is selected from NaPF₆/TMSP and NaPF₆/HFPM; and

as a further improvement of the technical solutions, in the ester solvent, the composition of the adaptive components capable of compensating potassium and electrons is selected from KPF₆/TMSP and KTFSI/TMPi.

As a further improvement of the technical solutions, in the ether solvent, the solvent is selected from a combination of DME/DOL;

as a further improvement of the technical solutions, in the ether solvent, the adaptive additive capable of compensating ions and electrons simultaneously is selected from one or more of LiP₅, LiP₇, NaP₅, NaP₇, KP₅ and K₃P₇;

as a further improvement of the technical solutions, in the ether solvent, the adaptive composition of the components capable of compensating lithium and electrons is selected from LiFSI/VC and LiTFSI/TMSP;

as a further improvement of the technical solutions, in the ether solvent, the composition of the adaptive components capable of compensating sodium and electrons is selected from NaPF₆/TMSP and NaClO₄/EFE; and

as a further improvement of the technical solutions, in the ether solvent, the composition of the adaptive components capable of compensating potassium and electrons is selected from KTFSI/TMPi and KFSI/TPPi.

As a further improvement of the technical solutions, in the sulfone solvent, the solvent is selected from DMSO;

as a further improvement of the technical solutions, in the sulfone solvent, the adaptive additive capable of compensating ions and electrons simultaneously is selected from one or more of LiP₅, NaP₅, NaP₇ and KP₅; and

as a further improvement of the technical solutions, in the sulfone solvent, the composition of the adaptive components capable of compensating lithium and electrons is selected from LiFSI/VC and LiTFSI/TMSP.

As a further improvement of the technical solutions, the nitrile solvent is selected from AN and SN, and the adaptive additive is selected from one or more of LiP₇, NaP₇ and K₃P₇;

as a further improvement of the technical solutions, in the nitrile solvent, the adaptive additive capable of compensating ions and electrons simultaneously is selected from one or more of LiP₅, NaP₅, NaP₇ and KP₅; and

as a further improvement of the technical solutions, in the nitrile solvent, the composition of the adaptive components capable of compensating lithium and electrons is selected from LiFSI/VC and LiTFSI/TMSP.

As a further improvement of the technical solutions, a mass percent of the electrolyte additive dissolved in the electrolyte is 0.1%-25%.

As a further improvement of the technical solutions, a mass percent of the electrolyte additive dissolved in the electrolyte is 8%-12%.

As a further improvement of the technical solutions, the mass percent of the electrolyte additive dissolved in the electrolyte is preferably 10%.

As a further improvement of the technical solutions, a mass ratio of the components capable of compensating ions and electrons is 1:20-20:1.

As a further improvement of the technical solutions, the mass ratio of the components capable of compensating ions and electrons is 1:5-5:1.

As a further improvement of the technical solutions, the mass ratio of the components capable of compensating ions and electrons is preferably 1:2-1:1.

As a further improvement of the technical solutions, in the lithium-ion battery, the electrolyte salt is selected from one or more combinations of lithium hexafluorophosphate (LiPF₆), lithium tetrafluoroborate (LiBF₄), lithium perchlorate (LiClO₄), lithium hexafluoroarsenate (LiAsF₆), lithium bis(oxalate) borate (LiBOB), lithium difluoro(oxalato) borate (LiDFOB), lithium bis(fluorosulfonyl) imide (LiFSI), lithium bis(trifluoromethanesulfonyl) imide (LiTFSI), lithium trifluoromethanesulfonate (LiCF₃SO₃), lithium bis(trifluoromethylsulfonyl) imide (LiN(CF₃SO₂)₂) and lithium tetrafluorooxalate phosphate (LiPF₄(C₂O₄)); and

as a further improvement of the technical solutions, in the lithium-ion battery, the electrolyte salt is selected from one or more combinations of LiPF₆, LiBOB, LiDFOB, LiFSI and LiTFSI.

As a further improvement of the technical solutions, in the sodium-ion battery, the electrolyte salt is selected from one or more combinations of sodium perchlorate (NaClO₄) and sodium hexafluorophosphate (NaPF₆); and

as a further improvement of the technical solutions, in the sodium-ion battery, the electrolyte salt is NaPF₆.

As a further improvement of the technical solutions, in the potassium-ion battery, the electrolyte salt is selected from one or more combinations of potassium hexafluorophosphate (KPF₆), potassium bis(trifluoromethanesulfonly) imide (KTFSI) and potassium bis(fluorosulfonyl) imide (KFSI); and

as a further improvement of the technical solutions, in the potassium-ion battery, the electrolyte salt is KFSI.

In order to solve the other problem of the present application, the present application adopts the following technical solutions:

A secondary battery, includes a cathode, an anode, a separator and an electrolyte, wherein the electrolyte is the capacity-compensation electrolyte as described above.

As a further improvement of the technical solutions, the secondary ion battery includes a lithium-ion battery, a sodium-ion battery or a potassium-ion battery;

as a further improvement of the technical solutions, the cathode of the lithium-ion battery is selected from one or more of LiCoO₂, LiNiO₂, LiMn₂O₄, LiNi_{0.5}Mn_{1.5}O₄, Li₃V₂(PO₄)₃, LiFePO₄, LiNiₐCo_{b}Mn_{1-a-b}O₂, LiNi_{c}Co_{d}Al_{1-c-d}O₂ and S, where 0<a, b, c, d<1; and

as a further improvement of the technical solutions, the cathode of the sodium-ion battery is selected from one or more of sodium cobaltate, sodium manganate, sodium nickelate, sodium vanadate, sodium manganese phosphate, sodium iron phosphate, sodium vanadium phosphate, nickel-iron sodium manganate and sodium-rich sodium manganate.

As a further improvement of the technical solutions, the cathode of the potassium-ion battery is selected from one or more of a potassium-containing Prussian blue analogue, KMO₂, K₃V₂(PO₄)₂F₃, KVOPO₄, KVPO₄F, K₄Fe₃(PO₄)₂(P₂O₇), KFeC₂O₄ and K₄Fe₃(C₂O₄)₃(SO₄)₂, where, M in KMO₂ is a transition metal.

As a further improvement of the technical solutions, the anode is selected from one or more of artificial graphite, natural graphite, a carbon-based anode, a carbon nanotube, silicon and alloys thereof, tin and alloys thereof, germanium and alloys thereof, a phosphorus-based anode, a lithium metal, a sodium metal, a potassium metal, Li₄Ti₅O₁₂ and a transition metal compound MᵢXₖ, where, M is a metal element, X is selected from O, S, F and N, 0<i<3, and 0<k<4.

As a further improvement of the technical solutions, MᵢXₖ is selected from Fe₂O₃, Co₃O₄, MoS₂ and SnO₂.

As a further improvement of the technical solutions, a cathode/anode system is selected from the group consisting of LiNi_{0.8}Co_{0.1}Mn_{0.1}O₂/artificial graphite, LiNi_{0.5}Co_{0.2}Mn_{0.3}O₂/nano-silicon, LiNi_{0.5}Co_{0.2}Mn_{0.3}O₂/red phosphorus-CNT, LiNi_{0.5}Co_{0.2}Mn_{0.3}O₂/graphite, LiMn₂O₄/Li metal, LiCoO₂/red phosphorus-CNT, LiCoO₂/SnO₂, LiCoO₂/Co₃O₄, LiFePO₄/graphite, LiFePO₄/lithium metal, LiFePO₄/silicon, LiFePO₄/SnO₂, a sodium manganate/black phosphorus-graphite compound, sodium vanadium phosphate/hard carbon, potassium-containing Prussian blue/graphite and K₄Fe₃(C₂O₄)₃(SO₄)₂/soft carbon.

Compared with the prior art, the present disclosure has the advantages of evenly compensating ions and electrons and compensating for various capacity losses caused in the cycle process of the battery. Repeated experiments prove that the compensation type electrolyte of the present disclosure not only can improve the initial Coulomb efficiency of the secondary battery effectively, but can also improve the cycle stability and the capacity retention rate of the battery. The additive or a decomposed product thereof can also achieve certain functional effects in the electrolyte solution: some phosphate additives as described above can achieve a flame-retardant function in the electrolyte solution; for example, solvated products of P₅⁻ or P₇⁻ have certain kinetic activity; if the solvated products are gaseous, they can be removed through exhaust after activation, and have no obvious influence on properties of the battery; and if the solvated products exhibit a solid state, such as P or lithium polyphosphide, they may participate in generation of CEI and SEI, a thereby improving the cycle stability of the battery under a synergistic effect on surfaces of electrodes. Damage of gas release to the electrode structures during the active ion removing process can be effectively avoided by adding substances to the electrolyte in the form of the additive. And the challenges caused by lithium metal powder to production technologies and production safety are avoided, and the electrolyte is more easily compatible with existing production equipment.

Any range as recorded by the present disclosure is intended to include end values and any value between end values and any sub-range subsumed or defined therein.

### BRIEF DESCRIPTION OF THE DRAWINGS

FIG. 1 is a comparison diagram of cycle properties of Embodiment 1 and Comparative Example 1.

FIG. 2 is a comparison diagram of cycle properties of Embodiment 6 and Comparative Example 2.

### DETAILED DESCRIPTION OF THE PRESENT DISCLOSURE

Specific implementations of the present disclosure will be described below. Apparently, the described embodiments are only a part of embodiments of the present disclosure rather than all embodiments. All other embodiments obtained by those ordinarily skilled in the art without involving inventive effort based on the embodiments in the present disclosure fall within the protection scope of the present disclosure.

The present disclosure provides a capacity-compensation electrolyte, including a non-aqueous organic solvent, an electrolyte salt and a capacity-compensation electrolyte additive capable of compensating ions and electrons, which can compensate for active ions and electrons lacked by SEI formed in the first cycle and active substance losses in the cycle process.

Wherein the electrolyte additive includes:

a component capable of compensation ions and electrons simultaneously, or

a composition of a component capable of compensating ions and a component capable of compensating electrons;

the component capable of compensating ions and electrons simultaneously refers to a component capable of decomposing and releasing active ions and electrons simultaneously in the electrolyte during the working process of the battery;

the component capable of compensating ions refers to a component capable of decomposing and releasing active ions in the electrolyte during the working process of the battery; and

the component capable of compensating electrons refers to a component capable of decomposing and releasing electrons in the electrolyte during the working process of the battery.

The active ions refer to ions capable of being reversibly deintercalated between a cathode and an anode of a secondary battery.

In reported lithium compensation technologies, the lithium compensation additive is mostly added to electrodes, while lithium compensation in the electrodes has the risk of irreversible damage to electrode plates in the decomposition process. Negative effects on the electrodes can be avoided in a lithium compensation mode of the electrolyte. However, existing reports on the lithium compensation mode of the electrolyte have the phenomenon of poor compatibility between some lithium salts and an electrolyte solvent, so that a co-solvent needs to be additionally added. In the existing reports, usually the lithium compensation effect can be achieved only in the first cycle, and capacity losses caused by the reasons such as volume expansion and pulverization in the cycle process cannot be compensated.

The present disclosure creatively provides a solution capable of compensating ions and electrons simultaneously, the purpose of compensating electrons is to perform decomposition prior to other components in the electrolyte in the cycle process of the secondary battery, so as to supply needed electrons to capacity compensation, and the purpose of compensating ions is to supply needed ions to capacity compensation in the cycle process of the secondary battery. The component capable of compensating electrons is independently added, so that the active ions needed by capacity compensation cannot be supplied; and the component capable of compensating ions is independently added, it cannot decompose prior to other components in the electrolyte solution, so that active ions cannot be supplied. The electrons and the active ions needed by capacity compensation can be supplied in time when the active ion losses are generated in the cycle process of the battery only by compensating ions and electrons simultaneously, so as to ensure the good cycle property of the battery.

According to some implementations of the present application, the component capable of compensating ions and electrons simultaneously is selected from salts which contain active ion elements and have oxidation potential lower than that of a cathode material; and such salts can decompose prior to delithiation of the cathode material in the electrolyte during the working process of the battery to supply the active ions and the electrons needed by capacity compensation.

The component capable of compensating ions is selected from salts containing active ion elements; and such salts can supply additional active ions in the electrolyte during the working process of the battery, but they need to fit in with the component capable of compensation electrons to supply additional electrons for capacity compensation as their oxidation potential is high.

The component capable of compensating electrons is selected from one or more of ethers, sulfones, esters and thiophenes with oxidation potential lower than that of the cathode material; the ethers, the sulfones, the esters and the thiophenes can supply additional electrons in the electrolyte during the working process of the battery as their oxidation potential is usually low, and can achieve capacity compensation in combination with the component capable of compensating ions.

According to some implementations of the present application, in the lithium-ion battery, the component capable of compensating ions and electrons simultaneously includes one or more combinations of LiₓP_{y} and LiₘSₙ, where, 0<x≤3, 0<y≤11, 0<m≤3, and 0<n≤11;

according to some implementations of the present application, in the lithium-ion battery, preferably, 1≤x<3, and 4≤y≤10 in LiₓP_{y}, more preferably, LiₓP_{y} is selected from LiP₄, LiP₅, LiP₇, LiP₈ and LiP₁₀, and most preferably, is selecting from LiP₅ and LiP₇; and

according to some implementations of the present application, in the lithium-ion battery, preferably, 2≤m≤4, and 2≤n≤6 in LiₘSₙ, more preferably, LiₘSₙ is selected from Li₂S₄, Li₂S₆ and Li₂S₈, and most preferably, is selected from Li₂S₄ and Li₂S₆.

The preferred additives can be compatible with common electrolyte solvents and electrolyte salts, and all can achieve the capacity compensation effect in various systems of the lithium-ion batteries.

According to some implementations of the present application, in the sodium-ion battery, preferably, 1≤p<3, and 4≤q≤10 in the component NaₚP_{q} capable of compensating sodium and electrons simultaneously, and more preferably, NaₚP_{q} is selected from NaP₄, NaP₅, NaP₇ and Na₃P₇, and most preferably, is selected from NaP₅ and NaP₇. The preferred additives can be compatible with the common electrolyte solvents and electrolyte salts, and all can achieve the capacity compensation effect in various systems of the sodium-ion battery.

According to some implementations of the present application, in the potassium-ion battery, preferably, 1≤e≤3, and 4≤f≤10 in the component KₑP_{f} capable of compensating potassium and electrons simultaneously, more preferably, KₑP_{f} is selected from KP₄, KP₅, KP₇ and K₃P₇, and most preferably, is selected from KP₅ and K₃P₇. The preferred additives can be compatible with the common electrolyte solvents and electrolyte salts, and all can achieve the capacity compensation effect in various systems of the potassium-ion battery.

Electrolyte lithium compensation additives in the prior art have the defects of poor compatibility with the electrolyte solvents. Researches on lithium polyphosphide mostly remain in these common lithium polyphosphide compounds such as Li₃P and Li₅P, which are mostly used to compensate lithium in electrodes or to modify lithium metal surfaces. The applicant tried to add Li₃P, Li₅P and the like to the electrolyte solution, but a large number of experiments have verified that these conventional lithium polyphosphide solids are hardly dissolved in the appropriate electrolyte, and the solubility of the currently available electrolyte solvents is very poor, so such lithium polyphosphide solids are not suitable to be used as the electrolyte lithium compensation additives.

After a long period of creative work, the applicant has developed an electrolyte formula in which soluble lithium polyphosphide and lithium polysulfide are used as the electrolyte additives. In the electrolyte formula, LiP₄, LiP₅, LiP₇, LiP₈, LiP₁₀, Li₂S₄, Li₂S₆ and Li₂S₈ with good compatibility with the electrolyte solution, and especially LiP₅, LiP₇, Li₂S₄ and Li₂S₆, are used as the additives to be dissolved in the common ester, ether, sulfone or nitrile organic solvents. Meanwhile, the applicant also has found that by adding one or more of lithium polyphosphide and lithium polysulfide capable of being dissolved in the electrolyte solvents to the electrolyte, the lithium polyphosphide and the lithium polysulfide can decompose on the surfaces of the electrodes prior to the electrolyte solvents, so as to achieve the excellent effect of compensating lithium and electrons, thereby compensating for capacity losses caused by SEI formed in the cycle process of the battery and dead lithium generated in the follow-up cycle process.

In the sodium-ion battery, the applicant has developed that by adding sodium polyphosphide, such as NaP₄, NaP₅, NaP₇ and NaP₁₀, capable of being dissolved in the electrolyte solvents to the electrolyte to be used as the additive, the additive can be compatible with the common electrolyte solvents and electrolyte salts and decomposes prior to the solvents in the electrolyte solution, so as to achieve the effect of compensating sodium and electrons, thereby compensating for capacity losses caused by SEI formed in the cycle process of the battery and dead sodium generated in the follow-up cycle process.

In the potassium-ion battery, the applicant has developed that by adding potassium polyphosphide, such as KP₄, KP₅, KP₇ and K₃P₇, capable of being dissolved in the electrolyte solvents to the electrolyte to be used as the additive, the additive can be compatible with the common electrolyte solvents and electrolyte salts and decomposes prior to the solvents in the electrolyte solution, so as to achieve the effect of compensating potassium and electrons, thereby compensating for capacity losses caused by SEI formed in the cycle process of the battery and dead potassium generated in the follow-up cycle process. These achievements and technical solutions are discovered and reported by the applicant for the first time.

The additive has high solubility in the common electrolyte solvents, has a low LUMO energy and a high HOMO energy, and can decompose prior to the electrolyte solvents. The additive decomposes on an anode side prior to the electrolyte solvents due to the LUMO energy lower than that of the electrolyte solvents, so that stable SEI is preferentially formed on the surface of the anode. The additive decomposes on a cathode side prior to the electrolyte solvents due to the HOMO energy higher than that of the electrolyte solvents, so that stable CEI is preferentially formed on the surface of the cathode. Thus, the additive can improve the stability of an electrode-electrolyte interface in the battery and improve the cycle property of the battery.

According to some implementations of the present application, the component capable of supplying electrons includes diethyl sulfone (DES), dimethyl sulfone (DMS), tris(trimethylsilyl) phosphite (TMSP), tri(pentafluorophenyl) phosphine (TPFPP), terthiophene (3THP), vinylene carbonate (VC) and phosphite P(X)(Y)(Z), where, X, Y and Z are equal to one or more combinations of OH, R, OR, Cl, SH, SR and R₂N (R═CₙH₂ₙ₊₁, phenyl and derivatives thereof and silyl and derivatives thereof). The component capable of supplying electrons contains low-valent phosphorus, sulfur and other elements or easily oxidized structures, and decomposes prior to the electrolyte solvents and the electrolyte salts in the cycle process of the battery, so as to supply electrons to capacity compensation.

According to some implementations of the present application, the component capable of supplying electrons further includes ether micromolecules with low oxidation potential: dimethoxyethane (DME), diethylene glycol dimethyl ether (DEGDME), triethylene glycol dimethyl ether (TEGDME), 1,1,2,2-tetrafluoroethyl-2,2,3,3-tetrafluoropropyl ether (TTE), 1,1,2,2-tetrafluoroethyl-2′,2′,2′-trifluoroethyl ether (HFE), ethyl nonafluorobutyl ether (EFE), diethylene glycol diethyl ether (G2E), 1,1,1,3,3,3-hexafluoroisopropyl methyl ether (HFPM), 1H,1H,5H-ocafluorentyl-1,1,2,2-tetrafluoroethyl ether (OFE), 2,2,2-trifluoroethyl ether (BTFE) and methyl nonafluorobutyl ether (MFE). The ether micromolecules have low oxidization potential, and can decompose prior to the electrolyte solvents and the electrolyte salts in the cycle process of the battery, so as to provide electrons to capacity compensation.

According to some implementations of the present application, the component capable of supplying electrons in the ester solvent is selected from the group consisting of tris(trimethylsilyl) phosphite (TMSP), tri(pentafluorophenyl) phosphine (TPFPP) or phosphite P(X)(Y)(Z), where, X, Y and Z are equal to one or more combinations of OH, R, OR, Cl, SH, SR and R₂N (R═CₙH₂ₙ₊₁, phenyl and derivatives thereof and silyl and derivatives thereof), and dimethoxyethane (DME), diethylene glycol dimethyl ether (DEGDME) and triethylene glycol dimethyl ether (TEGDME). The additive capable of supplying electrons is well compatible with the ester solvent, has approximate oxidation potential, and can preferentially decompose in a voltage window of the ester solvent, so as to supply electrons.

According to some implementations of the present application, in the ether electrolyte solvent, the component capable of supplying electrons is diethyl sulfone (DES), dimethyl sulfone (DMS), tris(trimethylsilyl) phosphite (TMSP), tri(pentafluorophenyl) phosphine (TPFPP) or vinylene carbonate (VC). The additive capable of supplying electrons is well compatible with the ether solvent, has approximate oxidation potential, and can preferentially decompose in a voltage window of the ether solvent, so as to supply electrons.

According to some implementations of the present application, when the secondary battery is the lithium-ion battery, the component capable of compensating electrons is selected from one or more of NaₚP_{q} and KₑP_{f}, where, 0<p≤3, 0<q≤11, 0<e≤3, and 0<f≤11; and

according to some implementations of the present application, in NaₚP_{q} and KₑP_{f}, 1≤p<3, 4≤q≤10, 1≤e≤3, and 4≤f≤10.

According to some implementations of the present application, preferably, NaₚP_{q} is selected from NaP₄, NaP₅, NaP₇ and NaP₁₀, and most preferably, is selected from NaP₅ and NaP₇. Preferably, the oxidation potential of NaₚP_{q} is lower than the decomposition potential of the solvent in the lithium-ion battery system, and NaₚP_{q} can decompose prior to the solvent, so as to supply electrons for capacity compensation.

According to some implementations of the present application, preferably, KₑP_{f} is selected from KP₄, KP₅, KP₇ and K₃P₇, and most preferably, is selected from KP₅ and K₃P₇. Preferably, the oxidation potential of KₑP_{f} is lower than the decomposition potential of the solvent in the lithium-ion battery system, and KₑP_{f} can decompose prior to the solvent, so as to supply electrons for capacity compensation.

According to some implementations of the present application, when the secondary battery is the potassium-ion battery, the component capable of compensating electrons is selected from one or more of NaₚP_{q}, where, 0<p≤3, and 0<q≤11.

According to some implementations of the present application, preferably, NaₚP_{q} is selected from NaP₄, NaP₅, NaP₇ and NaP₁₀, and most preferably, is selected from NaP₅ and NaP₇. Preferably, the oxidation potential of NaₚP_{q} is lower than the decomposition potential of the solvent in the potassium-ion battery system, and NaₚP_{q} can decompose prior to the solvent, so as to supply electrons for capacity compensation.

According to some implementations of the present application, in the lithium-ion battery, active ions needed to be supplemented are lithium ions, and the component capable of compensating lithium is selected from one or more combinations of lithium hexafluorophosphate (LiPF₆), lithium tetrafluoroborate (LiBF₄), lithium perchlorate (LiClO₄), lithium hexafluoroarsenate (LiAsF₆), lithium bis(oxalate) borate (LiBOB), lithium difluoro(oxalato) borate (LiDFOB), lithium bis(fluorosulfonyl) imide (LiFSI), lithium bis(trifluoromethanesulfonyl) imide (LiTFSI), lithium trifluoromethanesulfonate (LiCF₃SO₃), lithium bis(trifluoromethylsulfonyl) imide (LiN(CF₃SO₂)₂) and lithium tetrafluorooxalate phosphate (LiPF₄(C₂O₄)) The additive capable of supplying active ions is well compatible with the common electrolyte solvents, and can act in cooperation with the additive capable of supplying electrons, so as to achieve the capacity compensation effect.

According to some implementations of the present application, in the lithium-ion battery, the component capable of compensating lithium is selected from one or more combinations of LiPF₆, LiBOB, LiDFOB, LiFSI and LiTFSI; and preferably, the component capable of compensating lithium is selected from LiTFSI. The additive capable of supplying lithium ions is well compatible with the common electrolyte solvents and the additive capable of supplying electrons, can decompose in the voltage window of the battery to release active ions, and can achieve the capacity compensation effect under the combined action of the additive and the additive capable of compensating electrons.

According to some implementations of the present application, in the sodium-ion battery, active ions needed to be supplemented are sodium ions, the component capable of compensating sodium is selected from one or more combinations of sodium perchlorate (NaClO₄) and sodium hexafluorophosphate (NaPF₆), and preferably, the component capable of compensating sodium is NaPF₆. The additive capable of supplying sodium ions is well compatible with the common electrolyte solvents and the additive capable of supplying electrons, can decompose in the voltage window of the battery to release active ions, and can achieve the capacity compensation effect under the combined action of the additive and the additive capable of compensating electrons.

According to some implementations of the present application, in the potassium-ion battery, active ions needed to be supplemented are potassium ions, and the component capable of compensating potassium is selected from one or more combinations of potassium hexafluorophosphate (KPF₆), potassium bis(trifluoromethanesulfonly) imide (KTFSI) and potassium bis(fluorosulfonyl) imide (KFSI), and preferably, the component capable of compensating potassium is KFSI. The additive capable of supplying potassium ions is well compatible with the common electrolyte solvents and the additive capable of supplying electrons, can decompose in the voltage window of the battery to release active ions, and can achieve the capacity compensation effect under the combined action of the additive and the additive capable of compensating electrons.

According to some implementations of the present application, in the lithium-ion battery, the composition of the components capable of compensating lithium and electrons is selected from LiPF₆/TMSP, LiDFOB/MFE, LiFSI/VC and LiTFSI/TMSP. The components capable of compensating lithium and electrons have good compatibility, and can achieve the good capacity compensation effect when co-used in the lithium-ion battery.

According to some implementations of the present application, in the sodium-ion battery, the composition of the components capable of compensating sodium and electrons is selected from NaClO₄/EFE, NaPF₆/TMSP and NaPF₆/HFPM. The components capable of compensating lithium and electrons have good compatibility, and can achieve the good capacity compensation effect when co-used in the sodium-ion battery.

According to some implementations of the present application, in the potassium-ion battery, the composition of the component capable of compensating potassium and electrons is selected from KPF₆/TMSP, KTFSI/TMPi and KFSI/TPPi. The components capable of compensating potassium and electrons have good compatibility, and can achieve the good capacity compensation effect when co-used in the potassium-ion battery.

According to some implementations of the present application, the mass ratio of the component capable of compensating ions to the component capable of compensating electrons is 1:20-20:1, preferably, 1:5-5:1, and most preferably, 1:2-1:1. The ratio of the component capable of compensating ions to the component capable of compensating electrons can ensure that when the composition decomposes in the voltage window of the battery, the mutually-matched active ions and electrons are supplied simultaneously to carry out capacity compensation on the battery.

According to some implementations of the present application, the additives capable of compensating ions and electrons can be dissolved in one or more combinations in the organic solvent, there is no specific limitation on the ratio of mixed solvents, for example, EC:DEC=1:1, and EC:EMC:DMC=1:1:1.

According to some implementations of the present application, a mass percent of the electrolyte additive dissolved in the electrolyte is 0.1%-25%;

according to some implementations of the present application, the mass percentage of the electrolyte additive dissolved in the electrolyte is 8%-12%; and

according to some implementations of the present application, most preferably, the mass percentage of the electrolyte additive dissolved in the electrolyte is 10%. Too few additives may result in insufficient compensation for capacity losses caused by volume expansion and pulverization of electrodes in the cycle process, while introduction of too many additives may result in excessive additive mass, leading to reduction in whole energy density of the battery.

According to some implementations of the present application, the non-aqueous organic solvent in the electrolyte is selected from one or more of an ester solvent, an ether solvent, a sulfone solvent and a nitrile solvent;

preferably, the ester solvent is selected from one or more of ethylene carbonate (EC), diethyl carbonate (DEC), dimethyl carbonate (DMC), ethyl methyl carbonate (EMC), propylene carbonate (PC), Chloroethylene carbonate (Chloro-EC), ethyl propionate (EP) and propyl propionate (PP);

preferably, the ether solvent is selected from one or more of dimethoxyethane (DME) and 1,3-dioxolane (DOL);

preferably, the sulfone solvent is selected from one or more of sulfolane (SL) and dimethyl sulfoxide (DMSO); and

preferably, the nitrile solvent is selected from one or more of succinonitrile (SN) and hexanedinitrile (HN).

The additive capable of compensating ions and electrons simultaneously, the additive capable of compensating ions and the additive capable of compensating electrons are well compatible with one another in the solvents of the above types, and can achieve the effect of the electrolyte additive under a certain concentration.

According to some implementations of the present application, in the ester solvent, the solvent is selected from a combination of EC/DEC, EC/EMC, EC/EMC/DMC and PC/DMC;

according to some implementations of the present application, in the ester solvent, the adaptive additive capable of compensating ions and electrons simultaneously is selected from one or more of LiP₅, LiP₇, NaP₅, NaP₇, KP₅ and K₃P₇;

according to some implementations of the present application, in the ester solvent, the composition of the adaptive components capable of compensating lithium and electrons is selected from LiPF₆/TMSP and LiDFOB/MFE;

according to some implementations of the present application, in the ester solvent, the composition of the adaptive components capable of compensating sodium and electrons is selected from NaPF₆/TMSP and NaPF₆/HFPM; and

according to some implementations of the present application, in the ester solvent, the composition of the adaptive components capable of compensating potassium and electrons is selected from KPF₆/TMSP and KTFSI/TMPi.

In the ester solvent, the additives capable of compensating ions and electrons simultaneously and the composition of the additives capable of compensating ions and electrons have high solubility, so that they can be dissolved prior to the solvent, so as to achieve the capacity compensation effect.

According to some implementations of the present application, in the ether solvent, the solvent is selected from a combination of DME/DOL;

according to some implementations of the present application, in the ether solvent, the adaptive additive capable of compensating ions and electrons simultaneously is selected from one or more of LiP₅, LiP₇, NaP₅, NaP₇, KP₅ and K₃P₇;

according to some implementations of the present application, in the ether solvent, the composition of the adaptive components capable of compensating lithium and electrons is selected from LiFSI/VC and LiTFSI/TMSP;

according to some implementations of the present application, in the ether solvent, the composition of the adaptive components capable of compensating sodium and electrons is selected from NaPF₆/TMSP and NaClO₄/EFE; and

according to some implementations of the present application, in the ether solvent, the composition of the adaptive components capable of compensating potassium and electrons is selected from KTFSI/TMPi and KFSI/TPPi.

In the ether solvent, the additives capable of compensating ions and electrons simultaneously and the composition of the additives capable of compensating ions and electrons have high solubility, so that they can be dissolved prior to the solvent, so as to achieve the capacity compensation effect.

According to some implementations of the present application, in the sulfone solvent, the solvent is selected from DMSO;

according to some implementations of the present application, in the sulfone solvent, the adaptive additive capable of compensating ions and electrons simultaneously is selected from one or more of LiP₅, NaP₅, NaP₇ and KP₅; and

according to some implementations of the present application, in the sulfone solvent, the composition of the adaptive components capable of compensating lithium and electrons is selected from the group consisting of LiFSI/VC and LiTFSI/TMSP.

In the sulfone solvent, the additive capable of compensating ions and electrons simultaneously and the composition of the additives capable of compensating ions and electrons have high solubility, so that they can be dissolved prior to the solvent, so as to achieve the capacity compensation effect.

According to some implementations of the present application, the nitrile solvent is selected from AN and SN, and the adaptive additive is selected from one or more of LiP₇, NaP₇ and K₃P₇.

According to some implementations of the present application, in the nitrile solvent, the adaptive additive capable of compensating ions and electrons simultaneously is selected from one or more of LiP₅, NaP₅, NaP₇ and KP₅; and

according to some implementations of the present application, in the nitrile solvent, the adaptive composition of the components capable of compensating lithium and electrons is selected from LiFSI/VC and LiTFSI/TMSP.

In the nitrile solvent, the additive capable of compensating ions and electrons simultaneously and the composition of the additives capable of compensating ions and electrons have high solubility, so that they can be dissolved prior to the solvent, so as to achieve the capacity compensation effect.

According to some implementations of the present application, in the lithium-ion battery, the electrolyte salt is selected from one or more combinations of LiPF₆, LiBOB, LiDFOB, LiFSI and LiTFSI. The lithium salt and the additive do not undertake a chemical reaction, thereby achieving high compatibility.

According to some implementations of the present application, in the sodium-ion battery, the electrolyte salt is selected from one or more combinations of sodium perchlorate (NaClO₄) and sodium hexafluorophosphate (NaPF₆); and

according to some implementations of the present application, in the sodium-ion battery, the electrolyte salt is NaPF₆. The sodium salt and the additive do not undertake a chemical reaction, thereby achieving high compatibility.

According to some implementations of the present application, in the potassium-ion battery, the electrolyte salt is selected from one or more combinations of potassium hexafluorophosphate (KPF₆), potassium bis(trifluoromethanesulfonly) imide (KTFSI) and potassium bis(fluorosulfonyl) imide (KFSI); and

according to some implementations of the present application, in the potassium-ion battery, the electrolyte salt is KFSI. The potassium salt and the additive do not undertake a chemical reaction, thereby achieving high compatibility.

The present application further discloses a secondary ion battery, including a cathode, an anode, a separator and the electrolyte.

According to some implementations of the present application, the secondary ion battery includes a lithium-ion battery, a sodium-ion battery or a potassium-ion battery; and

according to some implementations of the present application, the cathode of the lithium-ion battery is selected from one or more of LiCoO₂, LiNiO₂, LiMn₂O₄, LiNi_{0.5}Mn_{1.5}O₄, Li₃V₂(PO₄)₃, LiFePO₄, LiNiₓCo_{y}Mn_{1-x-y}O₂, LiNiₓCo_{y}Al_{1-x-y}O₂ and S. The cathode material of the lithium-ion battery and the additive do not undertake a side reaction, thereby achieving high compatibility.

According to some implementations of the present application, the cathode of the sodium-ion battery is selected from one or more of sodium cobaltate, sodium manganate, sodium nickelate, sodium vanadate, sodium manganese phosphate, sodium iron phosphate, sodium vanadium phosphate, nickel-iron sodium manganate and sodium-rich sodium manganate. The cathode material of the sodium-ion battery and the additive do not undertake a side reaction, thereby achieving high compatibility.

According to some implementations of the present application, the cathode of the potassium-ion battery is selected from one or more of a potassium-containing Prussian blue analogue, KMO₂, K₃V₂(PO₄)₂F₃, KVOPO₄, KVPO₄F, K₄Fe₃(PO₄)₂(P₂O₇), KFeC₂O₄ and K₄Fe₃(C₂O₄)₃(SO₄)₂, where, M in KMO₂ is a transition metal. The cathode material of the potassium-ion battery and the additive do not undertake a side reaction, thereby achieving high compatibility.

According to some implementations of the present application, the anode is selected from artificial graphite, natural graphite, a carbon-based anode, a carbon nanotube, silicon and alloys thereof, tin and alloys thereof, germanium and alloys thereof, a phosphorus-based anode, a lithium metal, Li₄Ti₅O₁₂ or a transition metal compound MᵢXₖ, where, M is a metal element, X is selected from O, S, F or N, 0<i<3, and 0<k<4. Preferably, MᵢXₖ is selected from Fe₂O₃, Co₃O₄, MoS₂ and SnO₂. The anode material of the secondary battery and the additive do not undertake a side reaction, thereby achieving high compatibility.

According to some implementations of the present application, a cathode/anode system is selected from the group consisting of LiNi_{0.8}Co_{0.1}Mn_{0.1}O₂/artificial graphite, LiNi_{0.5}Co_{0.2}Mn_{0.3}O₂/nano-silicon, LiNi_{0.5} Co_{0.2}Mn_{0.3}O₂/red phosphorus-CNT, LiNi_{0.5}Co_{0.2}Mn_{0.3}O₂/graphite, LiMn₂O₄/Li metal, LiCoO₂/red phosphorus-CNT, LiCoO₂/SnO₂, LiCoO₂/Co₃O₄, LiFePO₄/graphite, LiFePO₄/lithium metal, LiFePO₄/silicon, LiFePO₄/SnO₂, a sodium manganate/black phosphorus-graphite compound, sodium vanadium phosphate/hard carbon, potassium-containing Prussian blue/graphite and K₄Fe₃(C₂O₄)₃(SO₄)₂/soft carbon. In the battery system, the additive capable of compensating ions and electrons simultaneously can preferentially decompose on a cathode, anode and electrolyte interface to carry out capacity compensation, and can form uniform and stable CEI and SEI films on surfaces of the cathode and the anode.

According to some implementations of the present application, the concentration of the electrolyte salt is not limited, and may be 1.0 mol/L, 1.2 mol/L, 1.5 mol/L, etc. as listed in embodiments.

The present disclosure will be described in detail below with reference to specific embodiments. Apparently, the listed embodiments are only a part of embodiments rather than all embodiments. Features in the embodiments can be mutually combined. All other embodiments obtained by those ordinarily skilled in art based on the present disclosure without involving creative labor should fall within the protection scope of the present disclosure. Conditions used by comparative examples are shown in Table 1.

### Embodiment 1

A capacity-compensation electrolyte, 10 wt % of LiP₅ was added to 1.0 mol/L of a LiPF₆-EC/DEC (volume ratio: 1/1) electrolyte under an inert gas atmosphere, and the materials were evenly mixed. The electrolyte was injected into a battery, where, a cathode material of the battery was LiNi_{0.8}Co_{0.1}Mn_{0.1}O₂, and an anode material of the battery was artificial graphite.

### Embodiment 2

A capacity-compensation electrolyte, 5 wt % of LiP₇, 2 wt % of LiP₈ and 2 wt % of LiP₁₀ were added to 1.2 mol/L of a LiBF₄-EC/DEC (volume ratio: 2/1) electrolyte under an inert gas atmosphere, and the materials were evenly mixed. The electrolyte was injected into a battery, where, a cathode material of the battery was LiNi_{0.5}Co_{0.2}Mn_{0.3}O₂, and an anode material of the battery was nano-silicon.

### Embodiment 3

A capacity-compensation electrolyte, 5 wt % of LiP, 5 wt % of LiP₄ and 5 wt % of LiP₈ were added to 1.0 mol/L of a LiPF₆-EC/DEC (volume ratio: 1/1) electrolyte under an inert gas atmosphere, and the materials were evenly mixed. The electrolyte was injected into a battery, where, a cathode material of the battery was LiNi_{0.5}Co_{0.2}Mn_{0.3}O₂, and an anode material of the battery was a ball milling material with a mass ratio of red phosphorus to CNT being 7:3.

### Embodiment 4

A capacity-compensation electrolyte, 0.1 wt % of LiP₄, 0.1 wt % of LiP₅ and 0.1 wt % of Li₃P₇ were added to 1.2 mol/L of a LiTFSI-EC/DEC (volume ratio: 1/1) electrolyte under an inert gas atmosphere, and the materials were evenly mixed. The electrolyte was injected into a battery, where, a cathode material of the battery was LiCoO₂, and an anode material of the battery was SnO₂.

### Embodiment 5

A capacity-compensation electrolyte, 10 wt % of LiP, 10 wt % of LiP₅ and 5 wt % of LiP₇ were added to 1.0 mol/L of a LiBOB-DOL/DME (volume ratio: 1/1) electrolyte under an inert gas atmosphere, and the materials were evenly mixed. The electrolyte was injected into a battery, where, a cathode material of the battery was LiMn₂O₄, and an anode material of the battery was a Li metal.

### Embodiment 6

A capacity-compensation electrolyte, 4 wt % of LiP₅, 2 wt % of LiP₇ and 2 wt % of Li₃P₇ were added to 1.0 mol/L of a LiPF₆-EC/EMC/DMC (volume ratio: 1/1/1) electrolyte under an inert gas atmosphere. The materials were evenly mixed. The electrolyte was injected into a battery, where, a cathode material of the battery was LiFePO₄, and an anode material of the battery was graphite.

### Embodiment 7

A capacity-compensation electrolyte, 2.5% by mass of LiFSI and 2.5% by mass of VC were added to 1.2 mol/L of a LiTFSI-EC/DEC (volume ratio: 2/1) electrolyte under an inert gas atmosphere. The electrolyte was injected into a battery, where, a cathode material of the battery was LiCoO₂, and an anode material of the battery was red phosphorus-CNT.

### Embodiment 8

A capacity-compensation electrolyte, 2.5 wt % of LiTFSI and 2.5% by mass of TMSP were added to 1.0 mol/L of a LiPF₆-EC/EMC/DMC (volume ratio: 1/1/1) electrolyte under an inert gas atmosphere, and the materials were evenly mixed. The electrolyte was injected into a battery, where, a cathode material of the battery was LiFePO₄, and an anode material of the battery was graphite.

### Embodiment 9

A capacity-compensation electrolyte, 4 wt % of LiDFOB and 4 wt % of MFE were added to 1.5 mol/L of a LiFSI-DOL/DME (volume ratio: 1/1) electrolyte under an inert gas atmosphere. The electrolyte was injected into a battery, where, a cathode material of the battery was LiFePO₄, and an anode material of the battery was a lithium metal.

### Embodiment 10

A capacity-compensation electrolyte, 0.1 wt % of LiP₇ and 2 wt % of DME were added to 1.0 mol/L of a LiBOB-PC/DEC (volume ratio: 1/1) electrolyte under an inert gas atmosphere. The electrolyte was injected into a battery, where, a cathode material of the battery was LiFePO₄, and an anode material of the battery was silicon.

### Embodiment 11

A capacity-compensation electrolyte, 5 wt % of LiP₅ and 5 wt % of Li₂S₄ were added to 1.0 mol/L of a LiTFSI-DOL/DME (volume ratio: 1/1) electrolyte under an inert gas atmosphere, and the materials were evenly mixed. The electrolyte was injected into a battery, where, a cathode material of the battery was LiFePO₄, and an anode material of the battery was SnO₂.

### Embodiment 12

A capacity-compensation electrolyte, 2 wt % of NaP₅ and 5 wt % of LiTFSI were added to 1.0 mol/L of a LiPF₆-EC/DEC (volume ratio: 1/1) electrolyte under an inert gas atmosphere, and the materials were evenly mixed. The electrolyte was injected into a battery, where, a cathode material of the battery was LiCoO₂, and an anode material of the battery was Co₃O₄.

### Embodiment 13

A capacity-compensation electrolyte, 5% by mass of NaP₅ and 5% by mass of NaP₇ were added to 1.0 mol/L of a NaPF₆-EC/DEC (volume ratio: 1/1) electrolyte under an inert gas atmosphere, and the materials were evenly mixed. The electrolyte was injected into a battery, where, a cathode material of the battery was sodium manganate, and an anode material of the battery was a black phosphorus-graphite compound.

### Embodiment 14

A capacity-compensation electrolyte, 7 wt % of NaPF₆ and 7 wt % of TMSP were added to 1.0 mol/L of a NaClO₄-EC/DMC (volume ratio: 1/1) electrolyte under an inert gas atmosphere, and the materials were evenly mixed. The electrolyte was injected into a battery, where, a cathode material of the battery was sodium vanadium phosphate, and an anode material of the battery was hard carbon.

### Embodiment 15

A capacity-compensation electrolyte, 8 wt % of NaPF₆ and 2 wt % of HFPM were added to 1.0 mol/L of a NaClO₄-EC/DEC (volume ratio: 1/1) electrolyte under an inert gas atmosphere, and the materials were evenly mixed. The electrolyte was injected into a battery, where, a cathode material of the battery was nickel-iron sodium manganate, and an anode material of the battery was hard carbon.

### Embodiment 16

A capacity-compensation electrolyte, 2 wt % of KFSI and 8 wt % of TPPi were added to 1.0 mol/L of a KTFSI-EC/DEC (volume ratio: 1/1) electrolyte under an inert gas atmosphere, and the materials were evenly mixed. The electrolyte was injected into a battery, where, a cathode material of the battery was potassium-containing Prussian blue, and an anode material of the battery was graphite.

### Embodiment 17

A capacity-compensation electrolyte, 5 wt % of KP₅ and 5 wt % of K₃P₇ were added to 1.2 mol/L of a KTFSI-EC/DMC (volume ratio: 1/1) electrolyte under an inert gas atmosphere, and the materials were evenly mixed. The electrolyte was injected into a battery, where, a cathode material of the battery was K₄Fe₃(C₂O₄)₃(SO₄)₂, and an anode material of the battery was soft carbon.

### Comparative Example 1

No additive was added to 1.0 mol/L of a LiPF₆-EC/DEC (volume ratio: 1/1) electrolyte under an inert condition. The electrolyte was injected into a battery, where, a cathode material of the battery was LiNi_{0.8}Co_{0.1}Mn_{0.1}O₂, and an anode material of the battery was artificial graphite.

### Comparative Example 2

No additive was added to 1.0 mol/L of a LiPF₆-EC/EMC/DMC (volume ratio: 1/1/1) electrolyte under an inert condition. The electrolyte was injected into a battery, where, a cathode material of the battery was LiFePO₄, and an anode material of the battery was graphite.

### Comparative Example 3

2.5 wt % of LiTFSI was added to 1.0 mol/L of a LiPF₆-EC/EMC/DMC (volume ratio: 1/1/1) electrolyte under an inert condition, and the materials were evenly mixed. The electrolyte was injected into a battery, where, a cathode material of the battery was LiFePO₄, and an anode material of the battery was graphite.

### Comparative Example 4

2.5 wt % of TMSP was added to 1.0 mol/L of a LiPF₆-EC/EMC/DMC (volume ratio: 1/1/1) electrolyte under an inert condition, and the materials were evenly mixed. The electrolyte was injected into a battery, where, a cathode material of the battery was LiFePO₄, and an anode material of the battery was graphite.

### Comparative Example 5

No additive was added to 1.0 mol/L of a NaPF₆-EC/DEC (volume ratio: 1/1) electrolyte under an inert condition. The electrolyte was injected into a battery, where, a cathode material of the battery was NaMnO2, and an anode material of the battery was a black phosphorus-graphite compound.

### Comparative Example 6

No additive was added to 1.0 mol/L of a KTFSI-EC/DEC (volume ratio: 1/1) electrolyte under an inert condition. The electrolyte was injected into a battery, where, a cathode material of the battery was potassium-containing Prussian blue, and an anode material of the battery was graphite.

A constant current charge and discharge test of the battery was carried out in an environment under the temperature of 25° C. The battery was activated at a current of 20 mA/g, and the battery was tested at a current of 100 mA/g. The capacity of the activated battery after the first discharge was D1, meanwhile, the capacity of the battery after 100 cycles was recorded as D200, D200/D1 was the capacity retention rate of the battery, and obtained results were shown in Table 2.

TABLE 1

| | | Additive capable | Additive | Additive | | | |
|---|---|---|---|---|---|---|---|
| | | of compensating | capable of | capable of | | | |
| | | ions and electrons | compensating | compensating | Electrolyte | | |
| No. | Group | simultaneously | ions | electrons | salt | Solvent | Cathode/anode |
| 1 | Embodiment 1 | 10 wt % LiP₅ | — | — | 1.0 mol/L | EC/DEC = 1/1 | LiNi_{0.8}Co_{0.1}Mn_{0.1}O₂/ |
| | | | | | LiPF₆ | | artificial graphite |
| 2 | Embodiment 2 | 5 wt % LiP₇, | — | — | 1.2 mol/L | EC/DEC = 2/1 | LiNi_{0.5}Co_{0.2}Mn_{0.3}O₂/ |
| | | 2 wt % LiP₈, | | | LiBF₄ | | nano-silicon |
| | | 2 wt % LiP₁₀ | | | | | |
| 3 | Embodiment 3 | 5 wt % LiP, | — | — | 1.0 mol/L | EC/DEC = 1/1 | LiNi_{0.5}Co_{0.2}Mn_{0.3}O₂/ |
| | | 5 wt % LiP₄, | | | LiPF₆ | | red phosphorus-CNT |
| | | 5 wt % LiP₈ | | | | | |
| 4 | Embodiment 4 | 0.1 wt % LiP₄, | — | — | 1.2 mol/L | EC/DEC = 1/1 | LiCoO₂/SnO₂ |
| | | 0.1 wt % LiP₅, | | | LiTFSI | | |
| | | 0.1 wt % Li₃P₇ | | | | | |
| 5 | Embodiment 5 | 10 wt % LiP, | — | — | 1.0 mol/L | DOL/DME = 1/1 | LiMn₂O₄/Li metal |
| | | 10 wt % LiP₅, | | | LiBOB | | |
| | | 5 wt % LiP₇ | | | | | |
| 6 | Embodiment 6 | 4 wt % LiP₅, | — | — | 1.0 mol/L | EC/EMC/DMC = | LiFePO₄/graphite |
| | | 2 wt % LiP₇, | | | LiPF₆ | 1/1/1 | |
| | | 2 wt % Li₃P₇ | | | | | |
| 7 | Embodiment 7 | — | 2.5 wt % | 2.5 wt % | 1.2 mol/L | EC/DEC = 2/1 | LiCoO₂/red |
| | | | LiFSI | VC | LiTFSI | | phosphorus-CNT |
| 8 | Embodiment 8 | — | 2.5 wt % | 2.5 wt % | 1.0 mol/L | EC/EMC/DMC = | LiFePO₄/graphite |
| | | | LiTFSI | TMSP | LiPF₆ | 1/1/1 | |
| 9 | Embodiment 9 | — | 4 wt % | 4 wt % | 1.0 mol/L | DOL/DME = 1/1 | LiFePO₄/lithium |
| | | | LiDFOB | MFE | LiFSI | | metal |
| 10 | Embodiment 10 | — | 0.1 wt % | 2 wt % | 1.0 mol/L | PC/DEC = 1/1 | LiFePO₄/silicon |
| | | | LiPF₆ | TMSP | LiBOB | | |
| 11 | Embodiment 11 | 5 wt % LiP₅ | — | — | 1.0 mol/L | DOL/DME = 1/1 | LiFePO₄/SnO₂ |
| | | 5 wt % Li₂S₄ | | | LiTFSI | | |
| 12 | Embodiment 12 | — | 5 wt % | 2 wt % | 1.0 mol/L | EC/DEC = 1/1 | LiCoO₂/Co₃O₄ |
| | | | LiTFSI | NaP₅ | LiPF₆ | | |
| 13 | Embodiment 13 | 5 wt % NaP₅ | — | — | 1.0 mol/L | EC/DEC = 1/1 | Sodium manganate/ |
| | | 5 wt % NaP₇ | | | NaPF₆ | | black phosphorus- |
| | | | | | | | graphite compound |
| 14 | Embodiment 14 | — | 7 wt % | 7 wt % | 1.0 mol/L | EC/DMC = 1:1 | Sodium vanadium |
| | | | NaPF₆ | TMSP | NaClO₄ | | phosphate/hard |
| | | | | | | | carbon |
| 15 | Embodiment 15 | — | 8 wt % | 2 wt % | 1.0 mol/L | EC/DEC = 1/1 | Nickel-iron sodium |
| | | | NaPF₆ | HFPM | NaClO₄ | | manganate/hard |
| | | | | | | | carbon |
| 16 | Embodiment 16 | — | 2 wt % | 8 wt % | 1.0 mol/L | EC/DEC = 1/1 | Potassium-containing |
| | | | KFSI | TPPi | KTFSI | | Prussian blue/graphite |
| 17 | Embodiment 17 | 5 wt % KP₅ | — | — | 1.2 mol/L | EC/DMC = 1:1 | K₄Fe₃(C₂O₄)₃(SO₄)₂/ |
| | | 5 wt % K₃P₇ | | | KFSI | | soft carbon |
| 18 | Comparative | — | — | — | 1.0 mol/L | EC/DEC = 1/1 | LiNi_{0.8}Co_{0.1}Mn_{0.1}O₂/ |
| | Example 1 | | | | LiPF₆ | | artificial graphite |
| 19 | Comparative | — | — | — | 1.0 mol/L | EC/EMC/DMC = | LiFePO₄/graphite |
| | Example 2 | | | | LiPF₆ | 1/1/1 | |
| 20 | Comparative | — | 2.5 wt % | — | 1.0 mol/L | EC/EMC/DMC = | LiFePO₄/graphite |
| | Example 3 | | LiTFSI | | LiPF₆ | 1/1/1 | |
| 21 | Comparative | — | — | 2.5 wt % | 1.0 mol/L | EC/EMC/DMC = | LiFePO₄/graphite |
| | Example 4 | | | TMSP | LiPF₆ | 1/1/1 | |
| 22 | Comparative | — | — | — | 1.0 mol/L | EC/DEC = 1/1 | Sodium manganate/ |
| | Example 5 | | | | NaPF₆ | | black phosphorus- |
| | | | | | | | graphite compound |
| 23 | Comparative | — | — | — | 1.0 mol/L | EC/DEC = 1/1 | Potassium-containing |
| | Example 6 | | | | KTFSI | | Prussian blue/graphite |

TABLE 2

| | | First-cycle | | |
|---|---|---|---|---|
| | | Coulomb | | Capacity |
| | | efficiency | D1 | retention rate |
| No. | Group | (%) | (mAh g⁻¹) | (%) |
| 1 | Embodiment 1 | 81.5 | 188.6 | 74.3 |
| 2 | Embodiment 2 | 84.5 | 207.5 | 71.0 |
| 3 | Embodiment 3 | 84.7 | 211.9 | 72.6 |
| 4 | Embodiment 4 | 85.0 | 212.4 | 73.4 |
| 5 | Embodiment 5 | 84.9 | 143.4 | 69.2 |
| 6 | Embodiment 6 | 88.2 | 145.8 | 79.9 |
| 7 | Embodiment 7 | 80.3 | 144.0 | 68.4 |
| 8 | Embodiment 8 | 87.6 | 145.1 | 75.6 |
| 9 | Embodiment 9 | 94.5 | 158.0 | 76.4 |
| 10 | Embodiment 10 | 85.2 | 157.7 | 70.1 |
| 11 | Embodiment 11 | 84.6 | 150.0 | 75.3 |
| 12 | Embodiment 12 | 78.4 | 132.5 | 60.4 |
| 13 | Embodiment 13 | 78.8 | 147.5 | 76.5 |
| 14 | Embodiment 14 | 76.2 | 93.6 | 82.1 |
| 15 | Embodiment 15 | 74.5 | 94.5 | 79.6 |
| 16 | Embodiment 16 | 73.5 | 92.4 | 75.8 |
| 17 | Embodiment 17 | 86.4 | 87.0 | 86.7 |
| 18 | Comparative Example 1 | 78.1 | 185.3 | 58.8 |
| 19 | Comparative Example 2 | 84.1 | 142.9 | 67.0 |
| 20 | Comparative Example 3 | 84.3 | 143.0 | 67.3 |
| 21 | Comparative Example 4 | 84.0 | 143.2 | 66.8 |
| 22 | Comparative Example 5 | 73.6 | 142.7 | 68.7 |
| 23 | Comparative Example 6 | 65.4 | 87.6 | 63.4 |

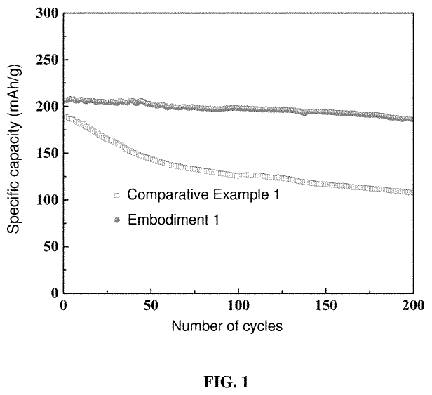

It could be shown from comparison between Comparative Example 1 and Embodiment 1 in FIG. 1 that after 10 wt % of LiP₅ was added to the ester electrolyte solution, the cycle stability and the capacity retention rate of the LiNi_{0.8}Co_{0.1}Mn_{0.1}O₂/artificial graphite full battery were both improved. It could be shown from data shown in Table 2 that the initial Coulomb efficiency of the full battery was also improved, which showed that LiP₅ could achieve the capacity compensation effect.

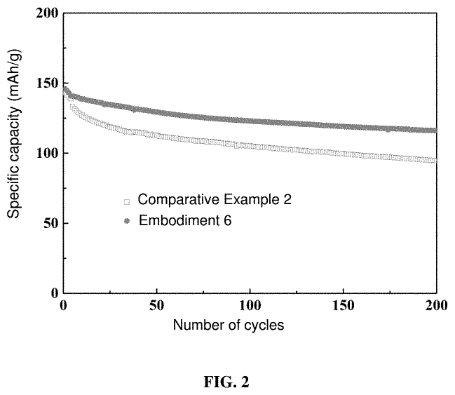

FIG. 2 illustrates cycle-specific capacity curves of Embodiment 6 and Comparative Example 2. It could be shown that after 8 wt % of LiₓP_{y} mixture was added, the initial Coulomb efficiency, the cycle reversible specific capacity and the capacity retention rate of the LiFePO₄/graphite full battery were all higher than those of Comparative Example 2, which showed that in the cycle process of the battery, active ions and electrons could be decomposed out of LiₓP_{y} to compensate for capacity losses in each process and achieve the effect of stabilizing the electrode-electrolyte interface, thereby improving the cycle property of the battery. It could be shown from data of Embodiment 8 and Comparative Examples 2, 3 and 4 shown in Table 2 that after the additive LiTFSI capable of compensating ions or the additive TMSP capable of compensating electrons was independently added, the initial Coulomb efficiency and the capacity retention rates of Comparative Examples 3 and 4 were similar to those of Comparative Example 2 without the additive, which showed that the battery could not be effectively subjected to capacity compensation by independently adding the additive capable of compensating ions or electrons, and ions and electrons could be supplemented simultaneously only when the additive capable of compensating ions or the additive capable of compensating electrons is used in combination as in Embodiment 8, thereby improving electrochemical properties of the battery.

It could be shown from data of the LiₓP_{y} compound added to the lithium-ion battery in Table 1 and Table 2 that the solubilities of LiP₄, LiP₅, LiP₇, LiP₈ and LiP₁₀ in the common electrolyte solvents such as the ester solvent and the ether solvent were high, and they could be used as the electrolyte additive to release active lithium ions and electrons for capacity compensation through decomposition. LiₓP_{y} could make the battery achieve the stable cycle effect in each battery system.

It could be shown from the comparison of the capacity retention rate data of the lithium-ion battery system in Table 2 that the capacity retention rates of Embodiments 1, 6, 9 and 11 were high, which showed that when the mass percent of the additive was 8%-12%, the good capacity compensation effect could be achieved.

It could be shown from comparison between Comparative Example 5 and Embodiment 13 that after 5 wt % of NaP₅ and 5 wt % of NaP₇ were added to the sodium-ion battery system to be used as the capacity compensation additive, the two components could achieve the effect of compensating ions and electrons simultaneously, thereby improving the initial Coulomb efficiency and the cycle stability of the full battery.

It could be shown from comparison between Comparative Example 6 and Embodiment 16 that after 2 wt % of KFSI and 8 wt % of TPPi were added to the potassium-ion battery system, the components capable of compensating ions and electrons could act together to supply needed active ions and electrons to capacity losses caused in the cycle process, thereby improving the initial Coulomb efficiency and the cycle stability of the full battery.

It could be shown from Embodiment 12 that sodium polyphosphate was selected as the additive capable of compensating electrons in the lithium-ion battery LiCoO₂/Co₃O₄ system, and meanwhile, could achieving the capacity compensation function in conjunction with LiTFSI as the additive capable of compensating ions.

It could be shown from Embodiment 11 that lithium polyphosphate and lithium polysulfide were selected as the additives capable of compensating ions and electrons simultaneously together in the lithium-ion battery LiFePO₄/SnO₂ system, and could synergistically act, thereby improving the initial Coulomb efficiency and the cycle stability of the full battery.

Obviously, the embodiments are only used for clearly illustrating examples of the present disclosure rather than limiting it. Those skilled in the art can modify, combine and transform the embodiments.

1. A capacity-compensation electrolyte for a secondary battery, comprising: a non-aqueous organic solvent, an electrolyte salt and an electrolyte additive capable of compensating ions and electrons simultaneously;
wherein the electrolyte additive comprises:
a component capable of compensating ions and electrons simultaneously, or
a composition of a component capable of compensating ions and a component capable of compensating electrons;
the component capable of compensating ions and electrons simultaneously refers to a component capable of decomposing and releasing active ions and electrons simultaneously in the electrolyte during the working process of the battery;
the component capable of compensation ions refers to a component capable of decomposing and releasing active ions in the electrolyte during the working process of the battery; and
the component capable of compensation electrons refers to a component capable of decomposing and releasing electrons in the electrolyte during the working process of the battery.

2. The capacity-compensation electrolyte according to claim 1, wherein
the component capable of compensating ions and electrons simultaneously is selected from salts which contain active ions and have oxidation potential lower than that of a cathode material;
the component capable of compensating ions is selected from salts containing active ions; and
the component capable of compensating electrons is selected from one or more of ethers, sulfones, esters and thiophenes with oxidation potential lower than that of the cathode material.

3. The capacity-compensation electrolyte according to claim 1, wherein
the secondary battery comprises a lithium-ion battery, a sodium-ion battery or a potassium-ion battery;
when the secondary battery is the lithium-ion battery, the component capable of compensating ions and electrons simultaneously comprises one or more of LiₓP_{y} and LiₘSₙ, where, 0<x≤3, 0<y≤11, 2≤m≤4, and 2≤n≤8;
when the secondary battery is the sodium-ion battery, the component capable of compensating ions and electrons simultaneously comprises one or more of NaₚP_{q}, where, 0<p≤3, and 0<q≤11; and
when the secondary battery is the potassium-ion battery, the component capable of compensating ions and electrons simultaneously comprises one or more of KₑP_{f}, where, 0<e≤3, and 0<f≤11.

4. The capacity compensation electrolyte according to claim 3, wherein
when the secondary battery is the lithium-ion battery, the component capable of compensating ions and electrons simultaneously comprises one or more of LiₓP_{y} and LiₘSₙ, where, 1≤x<3, 4≤y≤10, 2≤m≤4, and 2≤n≤6;
when the secondary battery is the sodium-ion battery, the component capable of compensation ions and electrons simultaneously comprises one or more of NaₚP_{q}, where, 1≤p<3, and 4≤q≤10; and
when the secondary battery is the potassium-ion battery, the component capable of compensating ions and electrons simultaneously comprises one or more of KₑP_{f}, where, 1≤e≤3, and 4≤f≤10.

5. The capacity-compensation electrolyte according to claim 1, wherein
the component capable of compensating electrons comprises one or more of dimethoxyethane (DME), diethylene glycol dimethyl ether (DEGDME), triethylene glycol dimethyl ether (TEGDME), 1,1,2,2-tetrafluoroethyl-2,2,3,3-tetrafluoropropyl ether (TTE), 1,1,2,2-tetrafluoroethyl-2′,2′,2′-trifluoroethyl ether (HFE), ethyl nonafluorobutyl ether (EFE), diethylene glycol diethyl ether (G2E), 1,1,1,3,3,3-hexafluoroisopropyl methyl ether (HFPM), 1H,1H,5H-ocafluorentyl-1,1,2,2-tetrafluoroethyl ether (OFE), 2,2,2-trifluoroethyl ether (BTFE), methyl nonafluorobutyl ether (MFE), diethyl sulfone (DES), dimethyl sulfone (DMS), tris(trimethylsilyl) phosphite (TMSP), tri(pentafluorophenyl) phosphine (TPFPP), terthiophene (3THP), vinylene carbonate (VC) and phosphite;
wherein a general formula of the phosphite is P(X)(Y)(Z);
where, X, Y and Z are respectively selected from OH, R, OR, Cl, SH, SR and R₂N;
where, R is selected from one or more of CₙH₂ₙ₊₁, phenyl and derivatives thereof, and silyl and derivatives thereof.

6. The capacity-compensation electrolyte according to claim 1, wherein
the secondary battery comprises a lithium-ion battery, a sodium-ion battery or a potassium-ion battery;
when the secondary battery is the lithium-ion battery, the component capable of compensating electrons comprises one or more of NaₚP_{q} and KₑP_{f}, where, 0<p≤3, 0<q≤11, 0<e≤3, and 0<f≤11; and
when the secondary battery is the potassium-ion battery, the component capable of compensating electrons comprises one or more of NaₚP_{q}, where, 0<p≤3, and 0<q≤11.

7. The capacity-compensation electrolyte according to claim 1, wherein
the secondary battery comprises a lithium-ion battery, a sodium-ion battery or a potassium-ion battery;
when the secondary battery is the lithium-ion battery, the component capable of compensating ions is selected from one or more of lithium hexafluorophosphate (LiPF₆), lithium tetrafluoroborate (LiBF₄), lithium perchlorate (LiClO₄), lithium hexafluoroarsenate (LiAsF₆), lithium bis(oxalate) borate (LiBOB), lithium difluoro(oxalato) borate (LiDFOB), lithium bis(fluorosulfonyl) imide (LiFSI), lithium bis(trifluoromethanesulfonyl) imide (LiTFSI), lithium trifluoromethanesulfonate (LiCF₃SO₃), lithium bis(trifluoromethylsulfonyl) imide (LiN(CF₃SO₂)₂) and lithium tetrafluorooxalate phosphate (LiPF₄(C₂O₄));
when the secondary battery is the sodium-ion battery, the component capable of compensating ions is selected from NaClO₄ and/or NaPF₆; and
when the secondary battery is the potassium-ion battery, the component capable of compensating ions is selected from one or more of potassium hexafluorophosphate (KPF₆), potassium bis(trifluoromethanesulfonly) imide (KTFSI) and potassium bis(fluorosulfonyl) imide (KFSI).

8. The capacity-compensation electrolyte according to claim 1, wherein the mass of the electrolyte additive is 0.1%-25% of the total mass of the electrolyte solution.

9. The capacity-compensation electrolyte according to claim 1, wherein
the non-aqueous organic solvent is selected from one or more of an ester solvent, an ether solvent, a sulfone solvent and a nitrile solvent;
the ester solvent is selected from one or more of ethylene carbonate (EC), diethyl carbonate (DEC), dimethyl carbonate (DMC), ethyl methyl carbonate (EMC), propylene carbonate (PC), Chloroethylene carbonate (Chloro-EC), ethyl propionate (EP) and propyl propionate (PP);
the ether solvent is selected from one or more of dimethoxyethane (DME) and 1,3-dioxolane (DOL);
the sulfone solvent is selected from one or more of sulfolane (SL) and dimethyl sulfoxide (DMSO); and
the nitrile solvent is selected from one or more of succinonitrile (SN) and hexanedinitrile (HN).

10. A secondary battery, comprising a cathode, an anode, a separator and an electrolyte solution, wherein the electrolyte is the capacity-compensation electrolyte according to claim 1.

11. The secondary battery according to claim 10, wherein
the secondary battery comprises a lithium-ion battery, a sodium-ion battery or a potassium-ion battery;
when the secondary battery is the lithium-ion battery, the cathode is selected from one or more of LiCoO₂, LiNiO₂, LiMn₂O₄, LiNi_{0.5}Mn_{1.5}O₄, Li₃V₂(PO₄)₃, LiFePO₄, a nickel-cobalt-manganese ternary material LiNiₐCo_{b}Mn_{1--a-b}O₂, LiNi_{c}Co_{d}Al_{1-c-d}O₂ and S, where, 0<a<1, 0<b<1, 0<c<1, and 0<d<1;
when the secondary battery is the sodium-ion battery, the cathode is selected from one or more of sodium cobaltate, sodium manganate, sodium nickelate, sodium vanadate, sodium manganese phosphate, sodium iron phosphate, sodium vanadium phosphate, nickel-iron sodium manganate and sodium-rich sodium manganate; and
when the secondary battery is the potassium-ion battery, the cathode is selected from one or more of a Prussian blue analogue, KMO₂, K₃V₂(PO₄)₂F₃, KVOPO₄, KVPO₄F, K₄Fe₃(PO₄)₂(P₂O₇), KFeC₂O₄ and K₄Fe₃(C₂O₄)₃(SO₄)₂, where, M is a transition metal.

12. The secondary battery according to claim 10, wherein
the anode is selected from one or more of artificial graphite, natural graphite, a carbon-based anode, a carbon nanotube, silicon and alloys thereof, tin and alloys thereof, germanium and alloys thereof, a phosphorus-based anode, a lithium metal, Li₄Ti₅O₁₂ and a transition metal compound MᵢXₖ, where, M is a metal element, X is selected from O, S, F and N, 0<i<3, and 0<k<4.

13. An application of a capacity-compensation electrolyte for a secondary battery, comprising: a non-aqueous organic solvent, an electrolyte salt and an electrolyte additive capable of compensating ions and electrons simultaneously;
wherein the electrolyte additive comprises:
a component capable of compensating ions and electrons simultaneously, or
a composition of a component capable of compensating ions and a component capable of compensating electrons;
the component capable of compensating ions and electrons simultaneously refers to a component capable of decomposing and releasing active ions and electrons simultaneously in the electrolyte during the working process of the battery;
the component capable of compensation ions refers to a component capable of decomposing and releasing active ions in the electrolyte during the working process of the battery; and
the component capable of compensation electrons refers to a component capable of decomposing and releasing electrons in the electrolyte during the working process of the battery, and
a secondary battery, comprising a cathode, an anode, a separator and an electrolyte solution, wherein the electrolyte is the capacity-compensation electrolyte.

14. The secondary battery of claim 10, wherein
the component capable of compensating ions and electrons simultaneously is selected from salts which contain active ions and have oxidation potential lower than that of a cathode material;
the component capable of compensating ions is selected from salts containing active ions; and
the component capable of compensating electrons is selected from one or more of ethers, sulfones, esters and thiophenes with oxidation potential lower than that of the cathode material.

15. The secondary battery of claim 10, wherein
the secondary battery comprises a lithium-ion battery, a sodium-ion battery or a potassium-ion battery;
when the secondary battery is the lithium-ion battery, the component capable of compensating ions and electrons simultaneously comprises one or more of LiₓP_{y} and LiₘSₙ, where, 0<x≤3, 0<y≤11, 2≤m≤4, and 2≤n≤8;
when the secondary battery is the sodium-ion battery, the component capable of compensating ions and electrons simultaneously comprises one or more of NaₚP_{q}, where, 0<p≤3, and 0<q≤11; and
when the secondary battery is the potassium-ion battery, the component capable of compensating ions and electrons simultaneously comprises one or more of KₑP_{f}, where, 0<e≤3, and 0<f≤11.

16. The secondary battery of claim 15, wherein
when the secondary battery is the lithium-ion battery, the component capable of compensating ions and electrons simultaneously comprises one or more of LiₓP_{y} and LiₘSₙ, where, 1≤x<3, 4≤y≤10, 2≤m≤4, and 2≤n≤6;
when the secondary battery is the sodium-ion battery, the component capable of compensation ions and electrons simultaneously comprises one or more of NaₚP_{q}, where, 1≤p<3, and 4≤q≤10; and
when the secondary battery is the potassium-ion battery, the component capable of compensating ions and electrons simultaneously comprises one or more of KₑP_{f}, where, 1≤e≤3, and 4≤f≤10.

17. The secondary battery of claim 10, wherein
the component capable of compensating electrons comprises one or more of dimethoxyethane (DME), diethylene glycol dimethyl ether (DEGDME), triethylene glycol dimethyl ether (TEGDME), 1,1,2,2-tetrafluoroethyl-2,2,3,3-tetrafluoropropyl ether (TTE), 1,1,2,2-tetrafluoroethyl-2′,2′,2′-trifluoroethyl ether (HFE), ethyl nonafluorobutyl ether (EFE), diethylene glycol diethyl ether (G2E), 1,1,1,3,3,3-hexafluoroisopropyl methyl ether (HFPM), 1H,1H,5H-ocafluorentyl-1,1,2,2-tetrafluoroethyl ether (OFE), 2,2,2-trifluoroethyl ether (BTFE), methyl nonafluorobutyl ether (MFE), diethyl sulfone (DES), dimethyl sulfone (DMS), tris(trimethylsilyl) phosphite (TMSP), tri(pentafluorophenyl) phosphine (TPFPP), terthiophene (3THP), vinylene carbonate (VC) and phosphite;
wherein a general formula of the phosphite is P(X)(Y)(Z);
where, X, Y and Z are respectively selected from OH, R, OR, Cl, SH, SR and R₂N;
where, R is selected from one or more of CₙH₂ₙ₊₁, phenyl and derivatives thereof, and silyl and derivatives thereof.

18. The secondary battery of claim 10, wherein
the secondary battery comprises a lithium-ion battery, the sodium-ion battery or the potassium-ion battery;
when the secondary battery is the lithium-ion battery, the component capable of compensating electrons comprises one or more of NaₚP_{q} and KₑP_{f}, where, 0<p≤3, 0<q≤11, 0<e≤3, and 0<f≤11; and
when the secondary battery is the potassium-ion battery, the component capable of compensating electrons comprises one or more of NaₚP_{q}, where, 0<p≤3, and 0<q≤11.

19. The secondary battery of claim 10, wherein
the secondary battery comprises a lithium-ion battery, the sodium-ion battery or the potassium-ion battery;
when the secondary battery is the lithium-ion battery, the component capable of compensating ions is selected from one or more of lithium hexafluorophosphate (LiPF₆), lithium tetrafluoroborate (LiBF₄), lithium perchlorate (LiClO₄), lithium hexafluoroarsenate (LiAsF₆), lithium bis(oxalate) borate (LiBOB), lithium difluoro(oxalato) borate (LiDFOB), lithium bis(fluorosulfonyl) imide (LiFSI), lithium bis(trifluoromethanesulfonyl) imide (LiTFSI), lithium trifluoromethanesulfonate (LiCF₃SO₃), lithium bis(trifluoromethylsulfonyl) imide (LiN(CF₃SO₂)₂) and lithium tetrafluorooxalate phosphate (LiPF₄(C₂O₄));
when the secondary battery is the sodium-ion battery, the component capable of compensating ions is selected from NaClO₄ and/or NaPF₆; and
when the secondary battery is the potassium-ion battery, the component capable of compensating ions is selected from one or more of potassium hexafluorophosphate (KPF₆), potassium bis(trifluoromethanesulfonly) imide (KTFSI) and potassium bis(fluorosulfonyl) imide (KFSI).

20. The secondary battery of claim 10, wherein the mass of the electrolyte additive is 0.1%-25% of the total mass of the electrolyte solution.
